(19) United States
(12) Patent Application Publication
(10) Pub. No.: US 2026/0287029 A1
(43) Pub. Date: Sep. 24, 2026

(54) FREEWHEEL DEVICE WITH SLIDING SHOES AND A CAGE GUIDED ON THE SLIDING SHOES

(71) Applicant: Schaeffler Technologies AG & Co. KG, Herzogenaurach (DE)

(72) Inventors: Alexander Reimchen, Herzogenaurach (DE); Stefan Hofmann, Großenseebach (DE)

(73) Assignee: Schaeffler Technologies AG & Co. KG, Herzogenaurach (DE)

(21) Appl. No.: 18/874,201

(22) PCT Filed: Jun. 12, 2023
(86) PCT No.: PCT/DE2023/100442

§ 371 Date: Dec. 12, 2024

(30) Foreign Application Priority Data
Jul. 6, 2022 (DE) 10 2022 116 846.8

(51) Int. Cl. F16D 41/067; F16D 41/06

(52) U.S. Cl. CPC F16D 41/067; F16D 2041/0601

(57) ABSTRACT

A freewheel device includes a freewheel axis defining an axial direction, a freewheel ring, a cage arranged concentric to the freewheel ring, clamping elements and springs. The freewheel ring includes clamping ramps and sliding shoes. Each sliding shoe is arranged between two adjacent clamping ramps and includes a pair of flanks oriented in opposite tangential directions. The cage is guided on the pair of flanks tangentially about the freewheel axis and includes pockets and holders. At least one holder includes a first pair of projections arranged axially adjacent to one another. The first pair of projections protrude together from the cage into the holder. Each one of the clamping elements and each one of the springs is received in one of the pockets. Each one of the sliding shoes is received in one of the holders.

### CROSS-REFERENCE TO RELATED APPLICATIONS

This application is the United States National Phase of PCT Appln. No. PCT/DE 2023/100442 filed Jun. 12, 2023, which claims priority to German Application No. DE 102022116846.8 filed Jul. 6, 2022, the entire disclosures of which are incorporated by reference herein.

### TECHNICAL FIELD

The present disclosure relates to a freewheel device which is formed from a freewheel ring, a cage, clamping elements, and springs.

### BACKGROUND

A generic freewheel device is described in DE 10 2019 133 200 B3. The freewheel ring is an inner ring for a seat on a shaft. The clamping elements located in the freewheel cage are intended for clamping contact with an internally cylindrical clamping track, which is formed on an outer ring of the freewheel device or on a housing of a machine part. The clamping elements are clamping rollers and, when installed, are held in a free-running position relative to the clamping track via the cage and the inserted springs during free-running mode. In the locking mode, the clamping rollers run against the forces of the springs on the clamping ramps so that they are clamped between the clamping ramps and the clamping track. As soon as the direction of rotation of a freewheel ring is changed or overtaken in freewheeling, the clamping between the clamping rollers and the clamping track is released and the clamping rollers are moved back to the freewheeling position by means of the action of the springs.

The freewheel ring and the clamping track must be concentrically oriented to each other so that there is sufficient radial play between the clamping elements and the clamping track in the freewheel position and the position of the clamping rollers is exact in the locking function. This is done with the help of the sliding shoes which are formed as one piece with the freewheel ring. The sliding shoes protrude radially in the direction of the clamping tracks in such a way that the radial gap between them and the clamping track is as small as possible to ensure a minimum level of the desired concentricity even in extreme situations.

The position of the clamping rollers in relation to each other is secured by the pockets, also with the help of the springs. To ensure that the pockets are precisely oriented with the clamping ramps, the cage is held on the sliding shoes. The cage is equipped with holders for this purpose. Each of the sliding shoes engages in one of the holders and is tightly guided therein. A twisting of the cage around the freewheel axis and thus displacement of the pockets from their predetermined position to the clamping ramps is prevented.

When the freewheel is in operation, the cage is exposed to high mechanical stress due to the sudden change between the freewheel position and the locking function and the associated dynamics.

### SUMMARY

The present disclosure provides a freewheel for high loads that can be manufactured cost-effectively.

The disclosure describes the design of the cage, its positioning, and mounting on the sliding shoes, as well as improvements concerning the interaction of the cage and a freewheel ring of the freewheel.

The disclosure therefore also relates to a single cage for a freewheel device with all the features described above or below and relating to the shape of the recess.

According to the present disclosure, it is provided that at least one of the holders formed on the cage is provided with two projections on the inside of the holder. The projections are arranged to be axially adjacent to one another on the cage parallel to the axial direction of the freewheel axis and protrude in the tangential or circumferential direction from the cage into the recess. The projections protrude together in the direction of one of the flanks of the respective sliding shoe from the cage into the holder by the same distance or with different tangential distances from the cage structure into the recess.

The freewheel axis is also the rotation axis of the rotating freewheel ring and/or the rotation axis of the clamping track. In the context of the disclosure, the freewheel axis is defined as being axially oriented regardless of its actual position in space. Radial is therefore defined as perpendicular to the freewheel axis. Tangential is the orientation with a tangent which, at any point and in any plane, rests on a circumferential circle concentrically encircling the freewheel axis in a radial plane. The circumferential direction is thus a direction that runs along the curvature line around the freewheel axis of the circumferential circles.

The disclosed cage with its holders is no longer guided “over the entire surface” on the flanks of the sliding shoes. A niche is created between the two projections, through which the cage is no longer supported on this flank over its entire surface, but on a two-point bearing. This makes it possible to compensate for rigid contact or one-sided rigid tilting due to twisting between the cage and the sliding shoes under certain dynamic conditions. In addition, the niches provide additional space or storage or passages for lubricants.

In addition, the free space in the niches can be used to hold the springs. The clips of the springs can engage in this space without protruding disturbingly from the holders or without coming into unwanted contact with the sliding shoe. In addition, the projections can prevent material accumulation, material duplication or thickening on the cage. The latter increases the service life by saving material and avoiding voltage peaks during operation.

The cages are made of metal or plastic and/or a combination of materials. Particularly in the case of cages produced by injection molding and/or casting, the measure according to the disclosure also contributes to uniform wall thicknesses and wall thickness transitions on the cage.

The disclosed device can be applied to both categories of freewheel devices without changing the basic principle, i.e., to freewheel rings that are designed as an inner ring or as an outer ring. In the sense of this disclosure, the freewheel ring is the ring which has the clamping structures and the sliding shoes.

According to an example embodiment, the sliding shoes extend radially from the outer ring in the direction of the freewheel axis and thus the sliding shoes and the clamping ramps between the sliding shoes are oriented radially inward. The sliding shoes are fixed to the freewheel ring in both categories, i.e., in the freewheel in the freewheel inner ring or freewheel with freewheel outer ring category. Fixed means either immovably attached or made from a single piece, single material, integrally formed with the freewheel ring from the material of the freewheel ring.

To maintain the position of the cage during assembly and, if necessary, during operation, the cage may also be held in the axial direction in the freewheel. Therefore, an embodiment provides that at least one snap hook is formed in the respective holder. The snap hook(s) engage(s) axially behind the respective sliding shoe at an edge or surface of an axially facing front face of the sliding shoe. They do not require any additional installation space and can be integrated into the production of the cage.

However, an example embodiment provides that one or more nubs protrude from at least one of the projections, whereby the system or guide and its dynamic tuning behavior can be optimized even further. The nub(s) rest on one or both sides of the sliding shoe. This measure allows the movement between the sliding shoes and the cage to be improved, optimized, restricted, or fine-tuned. One embodiment provides that the nub or nubs on the flank are elastically pre-stressed in the direction in which the projections protrude together to guide the cage against the freewheel ring against the sliding shoe without play.

The cage may be guided relative to the sliding shoes without play and the pockets may be positioned relative to the ramps to be relatively free from displacement. In this sense, a further embodiment provides that two pairs of projections are formed in the holder. A first pair is opposite a first flank and the other pair is opposite a second flank of the sliding shoe. The cage is guided under the same conditions on both sides of the sliding shoe. This leads to symmetry and thus simplification in the design of the cage and the sliding shoes, as well as uniform distribution of load and support behavior in both tangential directions.

Larger reservoirs for lubricants. In an embodiment, two of the nubs, each elastically pre-stressed against one of the sliding shoes, lie opposite one another in the tangential or circumferential direction on the respective sliding shoes. The sliding shoe is thus elastically clamped between the projections, which ensures a symmetrical release of play of the cage relative to the freewheel ring.

A further embodiment provides that the respective nub is formed on a projection which, viewed in the axial direction, laterally follows a first front face of the sliding shoe, and the first front face is not covered by a cage. The system with the reduced clearance or the clearance-free clamping therefore acts at a position where the recess could otherwise widen and the play between the cage and the sliding shoe could be undesirably increased.

A further embodiment provides that, on one of the front faces, the respective sliding shoe received in one of the holders is at least partially covered by a connecting web of the cage and the other front face remains free. In this way, the sliding shoes of the freewheel ring can be pushed axially into the recesses from one side during assembly of the freewheel device. The connecting webs connect two adjacent pockets of the cage and at the same time axially delimit a recess which is designed to be tangentially or in the circumferential direction between these two pockets.

### BRIEF DESCRIPTION OF THE DRAWINGS

The present disclosure is explained in more detail below through exemplary embodiments. The drawings in FIGS. 1 to 8 are not to scale. In the drawings:

FIG. 1 shows an overall view of a freewheel device 1,

FIG. 2 shows the freewheel device 1 in an overall view, in which a pre-installation assembly 23 is shown separated from the freewheel ring 2 in the manner of an exploded view with the freewheel ring 2 in the foreground,

FIG. 3 shows the freewheel device 1 in an overall view, in which the pre-installation assembly 23 known from FIG. 2 is shown separated from the freewheel ring 2 with the pre-installation assembly 23 in the foreground in the manner of an exploded view,

FIG. 4 shows a cage 3 of the pre-installation assembly 23 shown in FIGS. 2 and 3 in an overall view,

FIG. 5 shows an overall view of a freewheel device 20,

FIG. 6 shows a pre-installation assembly with the cage 24, the clamping elements 4 and the springs 5 of the freewheel device 20 in an overall view,

FIG. 7 shows a detail of a section in a radial plane of the freewheel device 20, and

FIG. 8 shows a detail of a cage 24 in the radial plane 7 of the previous FIG. 7, which in this representation is freed from the freewheel ring 2 shown in FIG. 7.

### DETAILED DESCRIPTION

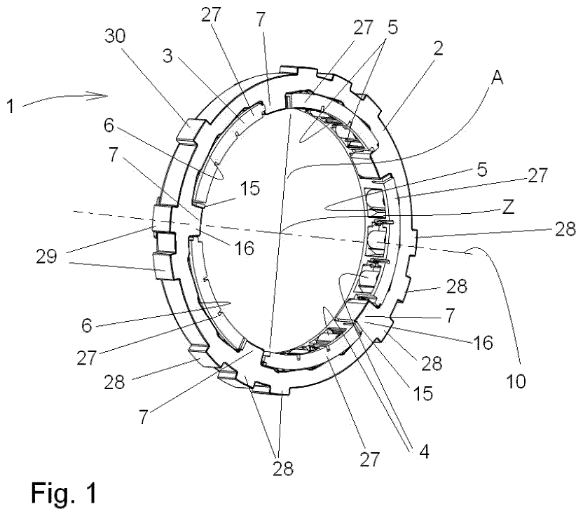

FIG. 1—The freewheel device 1 is formed from a freewheel ring 2, a cage 3, clamping elements 4, and springs 5. The freewheel ring 2 and the cage 3 are concentrically oriented with each other on an axially oriented freewheel axis 10. Sliding shoes 7 are formed as one piece with the freewheel ring 2. Clamping ramps 6 are formed between each two adjacent sliding shoes 7. The sliding shoes 7 and the clamping ramps 6 are oriented radially in the direction of the freewheel axis 10 and point theretowards. The radial direction runs perpendicular to the freewheel axis 10—for example the radial axis A, which intersects the central axis 10 at the center point Z. The cage 3 has segments 27 which are guided in the circumferential direction around the central axis 10 between the sliding shoes 7. Different groups of projections 28, 29, and 30 protrude radially outwards from the freewheel ring 2, which is designed as a freewheel outer ring. These projections 28 and 29 as well as 30 serve to prevent the freewheel ring 2 from rotating relative to a housing or component not shown. They are arranged on the circumference of the freewheel ring 2 in such a way that an axially direction-oriented installation of the freewheel device 1 is ensured, i.e., a reversal of the axial installation direction can be avoided.

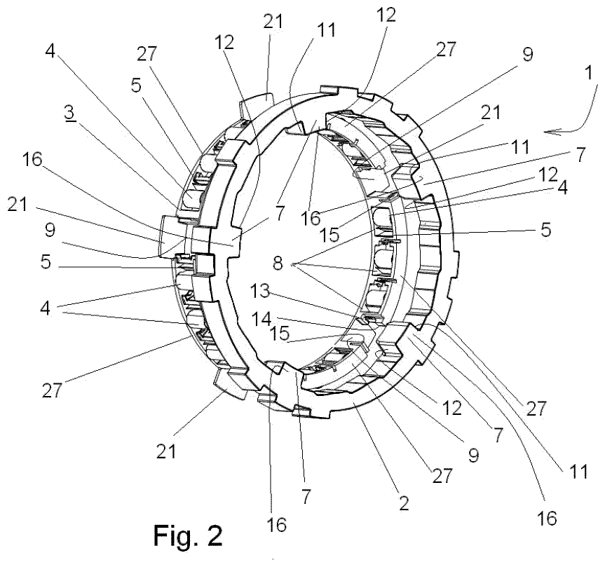

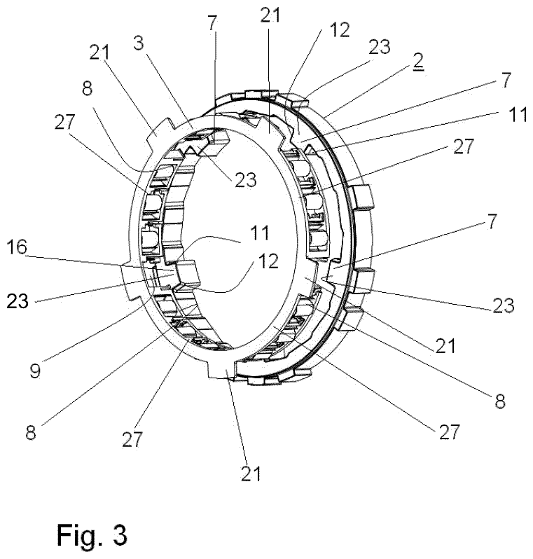

FIGS. 2 and 3—The cage 3 is provided with holders 9 between the segments 27. Each segment 27 is provided with three pockets 8. A clamping element 4 and a spring 5 are inserted into each of the pockets 8. In these illustrations, the cage 3 is located axially opposite the freewheel ring 2 in such a way that the holders 9 of the cage 3 point towards the sliding shoes 7. During axial movements of the cage 3 and the freewheel ring 2 towards each other, each of the sliding shoes 7 engages in one of the holders 9. The cage 3 and the freewheel ring 2 can be pushed axially into each other until the respective sliding shoe 7 comes to rest axially on a connecting web 21. The connecting web 21 limits the holder 9 axially in one direction and connects two of the segments 27. The cage 3 is guided on two flanks 11, 12 of the respective sliding shoe 7, or in the case shown, guided on the first flank 11 and guided on the second flank 12 and held with snap hooks 15.

FIG. 3—When the cage 3 and the freewheel ring 2 are mounted together, the front face 23 of the respective sliding shoe 7 is at least partially covered by a connecting web 21 of the cage 3.

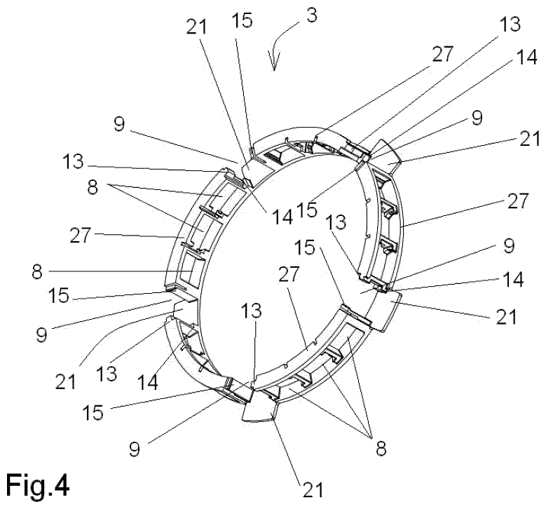

FIG. 4—The cage 3 is provided with holders 9 between the segments 27. Each segment 27 is provided with three pockets 8. The connecting web 21 limits the holder 9 axially in one direction and connects two of the segments 27. At least one snap hook 15 is formed in the respective holder 9, with which the respective sliding shoe 7 in the freewheel device 1 shown in FIG. 1 is axially engaged behind on a front face 16. In addition, each of the holders 9 is provided with two projections 13 and 14, which are arranged to be axially adjacent to one another parallel to the axial direction, and that protrude into the holder 9.

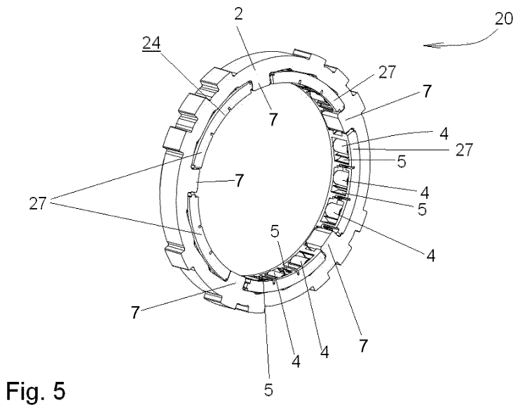

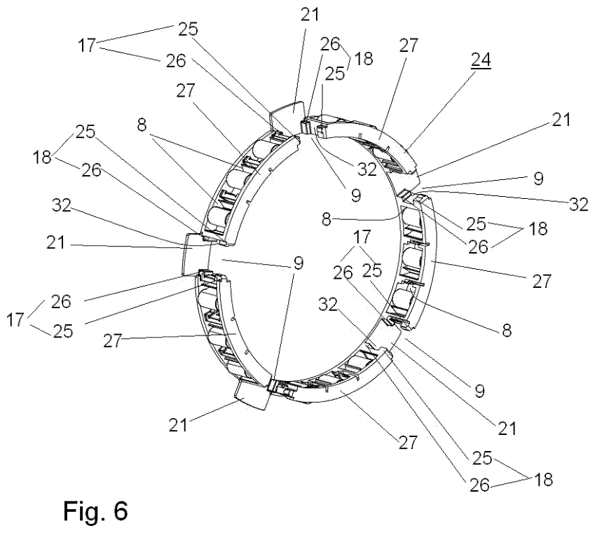

FIG. 5—The freewheel device 20 is formed from a freewheel ring 2, a cage 24, clamping elements 4, and springs 5. Sliding shoes 7 are formed as one piece with the freewheel ring 2. Clamping ramps 6 are formed between each two adjacent sliding shoes 7. The sliding shoes 7 and the clamping ramps 6 are directed radially inwards. The cage 24 has segments 27 which are guided in the circumferential direction between the sliding shoes 7. FIG. 6—The cage 24 is provided with holders 9 between the segments 27. Each segment is provided with three pockets 8. A clamping element 4 and a spring 5 are inserted into each of the pockets 8. The connecting web 21 limits the holder 9 axially in one direction and connects two of the segments 27. Two pairs 17 and 18 of projections 25 and 26 are formed in the respective holder 9. At least one nub 19 protrudes from the first projection 25 at the front of the holder 9. A niche 32 is formed between the projections 25 and 26 of the respective pair 17 or 18.

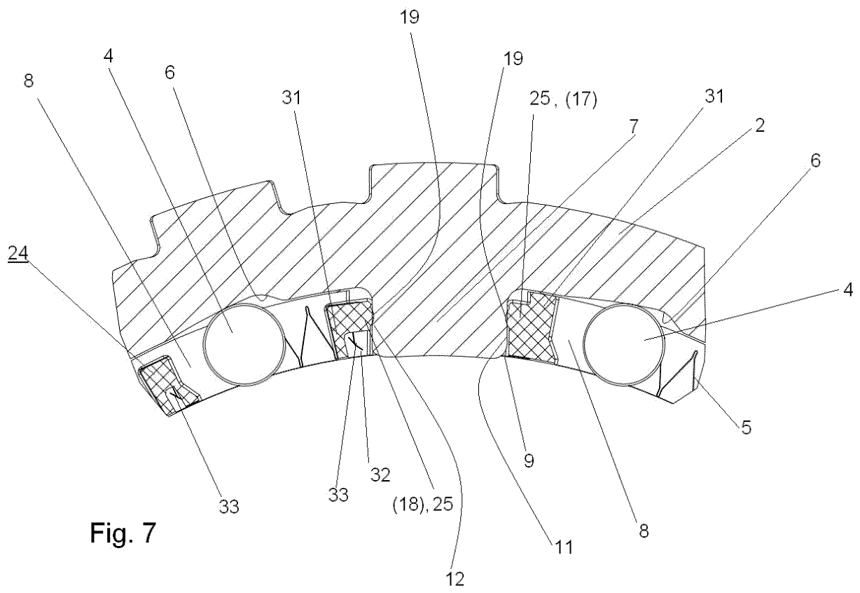

FIG. 7—Visible are the freewheel ring 2 with the sliding shoe 7, the cage 24 with a holder 9 that is almost filled by the sliding shoe 7 in the picture, two of the pockets 8 with clamping elements 4 and springs 5. The clamping elements 4 are assigned clamping ramps 6 of the freewheel ring 2, which is designed as a freewheel outer ring, since the clamping ramps 6 point radially inwards. The sliding shoe 7 sits in the holder 9. The pockets 8 adjoining the holder 9 to the left and right are delimited tangentially or in the circumferential direction in the direction of the holder 9 by a transverse web 31. The projection 25 is visible in the foreground on the respective transverse web 31. The respective spring 5 is clipped over the transverse web 31 with a spring clip 33 (visible only once in the cutout) and is thus held in the pocket 8 and positioned relative to the clamping element 4. The spring clip 33 engages in the free space formed by the niche 32 so that there is no contact between the flank 11 of the sliding shoe 7 and the spring clip 33.

A nub 19 is formed on the respective projection 25. The nub 19 of the projection 25 of the first pair 17 rests on the first flank 11 and the nub 19 of the projection 25 of the pair 18 rests on the second flank 12 of the sliding shoe 7. The nubs 19 located opposite each other on the holder 9 are elastically pre-stressed tangentially towards each other against the sliding shoe 7.

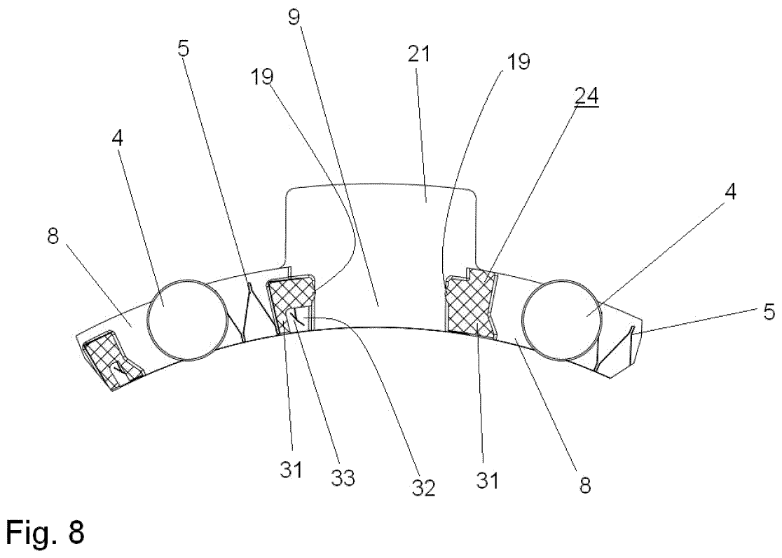

FIG. 8—Shown is a cross-section of a pre-installation assembly according to FIG. 6 with the cage 24, the clamping elements 4, and the springs 5. The pockets 8 adjoining the holder 9 to the left and right are delimited tangentially or in the circumferential direction in the direction of the holder 9 by a transverse web 31. The segments 27 adjoining the holder 9 are connected to one another by the connection 21. At least one nub 19 projects into the holder 9 from the respective first projection 25 located at the front of the holder 9. The pockets 8 adjoining the holder 9 to the left and right are delimited tangentially or in the circumferential direction in the direction of the holder 9 by a transverse web 31. The projection 25 is visible in the foreground on the respective transverse web 31. The respective spring 5 is clipped over the transverse web 31 with a spring clip 33. The spring clip 33 engages in the free space formed by the niche 32.

### REFERENCE NUMERALS

1 Freewheel device
2 Freewheel ring
3 Cage
4 Clamping element
5 Spring
6 Clamping ramp
7 Sliding shoe
8 Pocket of the cage
9 Holder
10 Freewheel axle
11 First flank of the sliding shoe
12 Second flank of the sliding shoe
13 First projection on the cage
14 Second projection on the cage
15 Snap-fit hook
16 First front face of the sliding shoe
17 First pair of projections
18 Second pair of projections
19 Nub
20 Freewheel device
21 Connecting web
22 Second front face of the sliding shoe
23 Pre-installation assembly
24 Cage
25 First projection
26 Second projection
27 Segment of the cage
28 Projection
29 Projection
30 Projection
31 Transverse web
32 Niche
33 Spring clip

1. A freewheel device which is formed from a freewheel ring, a cage clamping elements, and springs, wherein there is provided a concentric arrangement of the freewheel ring and the cage with respect to one another on an axially oriented freewheel axis, and:
clamping ramps oriented between two adjacent sliding shoes on the freewheel ring,
the cage is guided on the sliding shoes in a tangential direction around the freewheel axis and has pockets and holders,
at least one of the clamping elements and at least one of the springs are received in one of the pockets,
in each case a sliding shoe of the sliding shoes is received in one of the holders , wherein the cage is guided on two flanks of the respective sliding shoe, and a first of the flanks of the sliding shoe is oriented in a first tangential direction, and a second flank of the flanks is oriented in a second tangential direction opposite to the first tangential direction,
wherein at least one of the holders is provided with two projections which are arranged to be axially adjacent to one another and parallel to the axial direction of the freewheel axis, and wherein the projections protrude together in the direction of one of the flanks of the respective sliding shoe from the cage into the holder.

2. The freewheel device according to claim 1, wherein the sliding shoes extend radially in the direction of the freewheel axis from the freewheel ring and the clamping ramps are oriented radially inwards.

3. The freewheel device according to claim 1, wherein at least one snap hook is formed in the respective holder, which engages axially behind the respective sliding shoe on a front face.

4. The freewheel device according to claim 1, wherein at least one nub protrudes from at least a first projection of the projections, wherein the nub rests on one of the flanks.

5. The freewheel device according to claim 4, wherein the nub on the flank is elastically pre-stressed against the sliding shoe in the direction in which the projections protrude together.

6. The freewheel device according to claim 1, wherein two pairs of projections are formed in the holder, wherein a first pair is opposite a first flank and the other pair is opposite a second flank of the sliding shoe.

7. The freewheel device according to claim 6, wherein at least one nub protrudes from at least one protrusion of the protrusions of at least one of the pairs, and rests on one of the flanks of the respective sliding shoe against which one of the flanks is elastically tensioned.

8. The freewheel device according to claim 4, wherein two of the nubs, elastically pre-stressed against one of the sliding shoes, lie tangentially opposite one another on one of the sliding shoes.

9. The freewheel device according to claim 4, wherein the respective nub is formed on a projection which, viewed in the axial direction, laterally follows a first front face of the sliding shoe, wherein the first front face is not covered by the cage.

10. The freewheel device according to claim 1, wherein the respective sliding shoe received in one of the holders has a first front face and a second front face facing away from the first front face, wherein the flanks adjoin the front faces, wherein at least one front face of the front faces is at least partially covered by a connecting web of the cage, wherein the front face covered by the connecting web points in a direction aligned with the freewheel axis, and wherein the holder is delimited by the connecting web, and two of the pockets of the cage are connected to one another in the circumferential direction around the freewheel axis via the connecting web.

11. A freewheel device, comprising:
a freewheel axis defining an axial direction;
a freewheel ring arranged on the freewheel axis, the freewheel ring comprising:
a plurality of clamping ramps; and
a plurality of sliding shoes, each arranged between two adjacent ones of the plurality of clamping ramps and comprising a pair of flanks oriented in opposite tangential directions;
a cage arranged concentric to the freewheel ring and guided on the pair of flanks tangentially about the freewheel axis, the cage comprising:
a plurality of pockets; and
a plurality of holders, at least one holder of the plurality of holders comprising a first pair of projections arranged axially adjacent to one another parallel to the axial direction, the first pair of projections protruding together from the cage into the holder;
a plurality of clamping elements, each received in a one of the plurality of pockets; and
a plurality of springs, each received in a one of the plurality of pockets, wherein each one of the plurality of sliding shoes is received in a one of the plurality of holders.

12. The freewheel device of claim 11, wherein:
each one of the plurality of sliding shoes extends radially from the freewheel ring with respect to the freewheel axis; and
each one of the plurality of clamping ramps is oriented radially inwards.

13. The freewheel device of claim 11, wherein the cage further comprises at least one snap hook formed in a one of the plurality of holders, the at least one snap hook engaged axially behind a one of the plurality of sliding shoes on a face.

14. The freewheel device of claim 11, wherein a one of the first pair of projections comprises at least one nub protruding therefrom and resting on a one of the pair of flanks.

15. The freewheel device of claim 14, wherein:
the first pair of projections protrude in a direction; and
the at least one nub is elastically pre-stressed against a one of the plurality of sliding shoes in the direction.

16. The freewheel device of claim 11, wherein the at least one holder further comprises a second pair of projections, wherein:
the first pair of projections is arranged opposite a one of the pair of flanks; and
the second pair of projections is arranged opposite the other one of the pair of flanks.

17. The freewheel device of claim 16, wherein a one of the first pair of projections comprises at least one first nub protruding therefrom and resting on the one of the pair of flanks.

18. The freewheel device of claim 17, wherein the other one of the first pair of projections comprises at least one second nub protruding therefrom and resting on the other one of the pair of flanks, wherein the at least one first nub and the at least one second nub lie tangentially opposite one another.

19. The freewheel device of claim 17, wherein the one of the first pair of projections laterally follows a front face of the sliding shoe not covered by the cage when viewed in the axial direction.
